(19) United States
(12) Patent Application Publication
(10) Pub. No.: US 2017/0333761 A1
(43) Pub. Date: Nov. 23, 2017

(54) TOUCH ACTIVATED LIGHTED SPORTS BALL

(71) Applicants: Edward David Lewis, Brownsburg, IN (US); I PEE HOLDING, LLC, Vernon Hills, IL (US)

(72) Inventor: Edward David Lewis, Brownsburg, IN (US)

(21) Appl. No.: 15/443,311

(22) Filed: Feb. 27, 2017

Related U.S. Application Data
(60) Provisional application No. 62/300,345, filed on Feb. 26, 2016.

(51) Int. Cl. A63B 43/06; F21V 33/00; H05B 33/08

(52) U.S. Cl. CPC A63B 43/06; H05B 33/0803; F21V 33/008; A63B 2220/833

(57) ABSTRACT

A touch activated lighted sports ball is formed as a sphere having a core and an outer layer. A pair of electrodes are exposed on an exterior surface of the outer layer. An electronic circuit is disposed within the core. The electronic circuit has a battery, a lamp, an active circuit element, and an electronic switch. The electronic switch is connected to the pair of electrodes, and is responsive to current flowing through a low resistance path between the electrodes to energize the lamp.

### CROSS- REFERENCE TO RELATED APPLICATION DATA

This application claims the benefit of, and priority to Provisional U.S. Patent Application Ser. No. 62/300,345, filed Feb. 26, 2016, the disclosure of which is incorporated herein in its entirety.

### BACKGROUND

This present disclosure pertains to sports balls, more particularly, the disclosure pertains to a lighted sports ball providing visible indication of the ball location in darkness, and controls to provide for light activation.

Sporting activity are played around the clock, as a result, sporting equipment needs to work around the clock. The sport of golf has become a tremendously popular game, not just in the United States, but worldwide. The game has become so popular that it is often difficult to secure “tee” times at sufficiently reasonable hours to be able to play through nine or eighteen holes while still playing in daylight.

Because golf courses often have holes that average 300 to 400 yards in length and cover large areas, it is difficult, if not impossible, to illuminate an entire course to permit play at night. As such, golf is a particularly limited daytime game. Some “pitch and putt” courses may be sufficiently illuminated to permit play in the evening, however, most individuals that play golf would, of course, prefer to play a standard length course.

Attempts have been made to provide golf balls that are sufficiently visible in the dark to permit evening play. However, such golf balls are typically coated with luminous paints, or include the production of light from a chemical reaction, for example, such as, a chemiluminescent lighting device, and do not provide a sufficiently long period of bright or strong luminescence to permit play of an entire round of evening golf. One known device includes a chemiluminescent light stick that is inserted into an opening in the ball. When the light stick is activated, it emits a low luminescent light that is visible for a limited period of time. Such chemiluminescent golf balls may include a translucent outer skin or coating to permit a wider range of view of light emitted from the ball. However, those who have had occasion to use a chemiluminescent light sticks will recognize that such sticks often lose their ability to emit a relatively bright light in a short period of time. Moreover, such liquid chemiluminescent light stick inserts can affect the weight and balance of the ball, and thus the flight of the ball.

Another glow-in-the-dark golf ball includes a phosphorescent or luminescent glowing element that is molded within the center of the ball. The ball includes a translucent or transparent outer cover that permits the internal luminescent element to be viewed through the outer covering of the ball. However, these golf balls suffer from the same drawbacks as those that include chemiluminescent light sticks. Other illuminated golf balls include an embedded light emitting diode (LED) assembly with an impact-actuated, timed switch.

Sport balls, for example, such as, golf balls having lights installed therein are known in the art. However, as will be recognized by those skilled in the art and by those that play the game of golf, golf balls may not be visible along a fairway without daylight. As such, while attempts have been made to create golf balls that will provide a sufficient amount of light such that they can be seen along a fairway in the evening, such attempts have fallen short of creating a golf ball that can provide adequate visible light over extended periods of time, such as, the time it takes to play a full game of golf. Accordingly, there continues to be a need for an illuminated golf ball that emits sufficient light for an extended period of time, to permit clearly seeing a golf ball on a golf tee in twilight or low-light conditions, locating the ball, for example, along a fairway at night and withstand environmental conditions to which the ball may be subjected. The present disclosure is directed to such an endeavor.

### SUMMARY

The present disclosure may comprise one or more of the features recited in the attached claims, and/or one or more of the following features and combinations thereof.

In one aspect, an illustrative touch activated lighted sports ball, includes a sphere having at least a core and an outer layer, a pair of electrodes exposed on an exterior surface of the outer layer, and an electronic circuit is disposed within the core. The electronic circuit includes a battery, a lamp, an active circuit element, and an electronic switch. The electronic switch is connected to the pair of electrodes, and responsive to current flowing through a low resistance path between the electrodes, which turns on the lamp.

The sports ball may have a pair of electrodes arranged on opposite sides of the sphere equidistance apart. By having the pair of electrodes on opposite sides of the sphere, the ball may be balanced, a feature that may be important, if the sports ball is, for example, a golf ball. Golf may be a competitive sport and any advantage gained may improve player performance and, having a balanced ball may be an advantage for competitive golf players.

The sports ball may have a pair of electrodes arranged on the same sides of the sphere, side by side. By having the pair of electrodes on the same side of the sphere, the lamp may be easy to actuate, if the sports ball is, for example, a golf ball. Miniature golf, a recreational sport that may have younger player, for example, such as a child with small hands, may also benefit from the pair of electrodes on the same side of the golf ball. Easily actuating the golf ball lamp may be important to a child playing miniature golf at night.

The ball may include a plurality of dimples covering the exterior surface of the outer layer. The dimples may improve the aerodynamics of the ball. The pair of electrodes can be flush with the exterior surface of the outer layer with each centrally located within one of the plurality of dimples.

The outer layer may be transparent or translucent. When the lamp is on, light may be emitted through the outer layer. The emitted light may increase visibility of the sports ball when ambient light is low, for example, at night.

The active circuit element includes a timer for the period of time the lamp is energized subsequent to a low resistance path event across the pair of electrodes. The timer is initiated by the electronic switch when the low resistance path event occurs. When the timer expires the electronic switch may disconnect the active circuit from the battery and thereby deenergize the lamp.

The lamp may be a LED and may include a plurality of different color LEDs. The plurality of different color LEDs may be selectively lit, for example, individually and sequentially each time an electrical low resistance across the pair of electrodes is followed by an electrical high resistance across the pair of electrodes, and repeating until the plurality of color LEDs are cycled through and all LEDs are deenergized. The low resistance path may occur when the pair of electrodes are simultaneously touched by human skin, for example, the fingers and/or thumb of a user, or a conductive liquid, such as, for example water.

The sports ball may include other features and can be configured such that the touch activated circuit activates the LED light and controls the LED light in a pulse width modulated (PWM) manner. By PWM, instead of driving the LEDs with a constant voltage, the total amount of current used can be decreased. By decreasing the amount of current draw, the overall life of the battery and product may be extended.

The LED may also be de-energized by way of a voltage drop. For example, after the user turns the ball on, an internal voltage monitor compares a difference in voltage at a given time to the starting voltage as the battery depletes. The circuit can be configured such that if it is energized, it will remain energized for an additional voltage decay cycle if the activation switch is again contacted or re-contacted. The circuit can be configured so that the user can deactivate the circuit, for example touching the electrodes a predetermined number of times. That is, by monitoring a voltage drop, it can be determined that after a predetermined drop in voltage value of the internal battery, a predetermined amount of time has passed. Accordingly, the sports ball may operate without a timer actuated switch.

The circuit can also include an impact-type switch to energize the circuit in addition to the electrode activating the circuit. It can also be configured such that touching the electrodes operates in conjunction with the impact-type switch to illuminate the ball in one color and then, for example, upon striking, changing the illumination some other color, color pattern or intensity. In yet another option configuration, upon landing, if the impact-type switch is activated, it can be engaged to change colors or light intensity of the lamps for easy location of the ball.

The circuit and LEDs can also be configured so that the lights/illumination are provided in different colors, which colors may, for example, be selected by successive touching of the electrodes. The selected color may “lock” into place or may be reset by any of the aforementioned actions. The circuit may also configured to provide a continuous color changing mode (again by a some touch pattern of the electrodes when activating the circuit, and the user can then lock the illumination to the selected color, for example, unless or until the reset pattern is achieved or the circuit remains deenergized for a predetermined time.

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying figures in which:

FIG. 1 is a perspective view of an illustrative sports ball according to the present disclosure;

FIG. 2 is a hemispheric cross sectional illustration of the sports ball of FIG. 1;

FIG. 3 is a hemispheric cross sectional illustration of an alternative embodiment of the sports ball of FIG. 1;

FIG. 4 is a hemispheric cross sectional illustration of another alternative embodiment of the sports ball of FIG. 1;

FIG. 5 is an example of a schematic of the electronic circuit of the sports ball of FIG. 1;

FIG. 6 is an example of an alternative embodiment of a schematic of the electronic circuit of the sports ball of FIG. 1;

FIG. 7 is an illustration of the voltages in 20%, 50% and 80% duty cycles of Pulse Width Modulation scenarios;

FIGS. 8-12 illustrate various examples of the circuit configurations for the touch activated illuminated sports ball;

FIG. 13 is a plot of voltage drop vs. discharge capacity of the circuit;

FIGS. 14 and 15 are examples of operating flow diagrams for different circuits and scenarios for the touch activated illuminated sports ball;

FIG. 16 is an illustrative view of a sports ball held between the fingers of a user's hand to activate the circuit and light inside the ball; and

FIG. 17 is a hemispheric cross sectional illustration of another alternative embodiment of the sports ball of FIG. 1.

### DESCRIPTION OF THE ILLUSTRATIVE EMBODIMENTS

For the purposes of promoting and understanding the principles of the present disclosure, reference will now be made to one or more illustrative embodiments illustrated in the drawings and specific language will be used to describe the same.

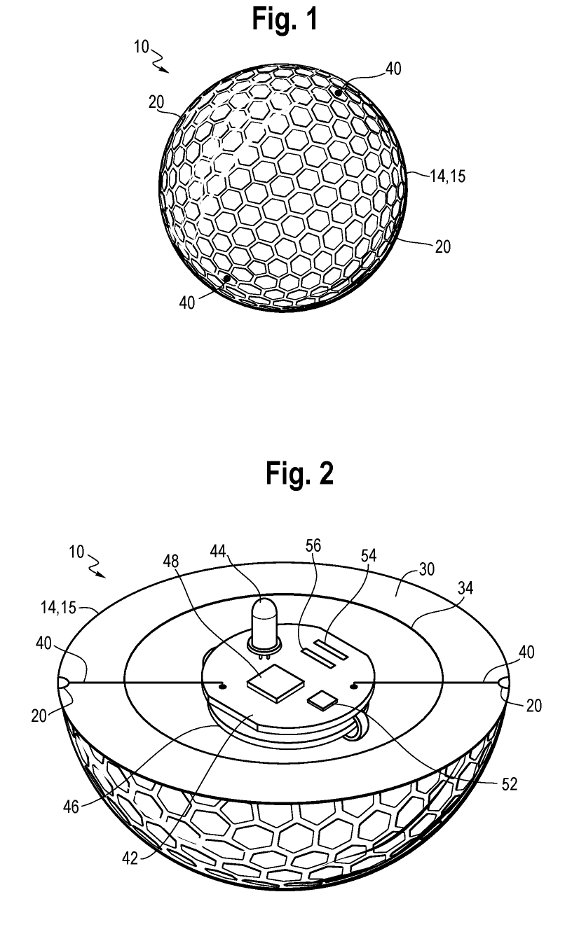

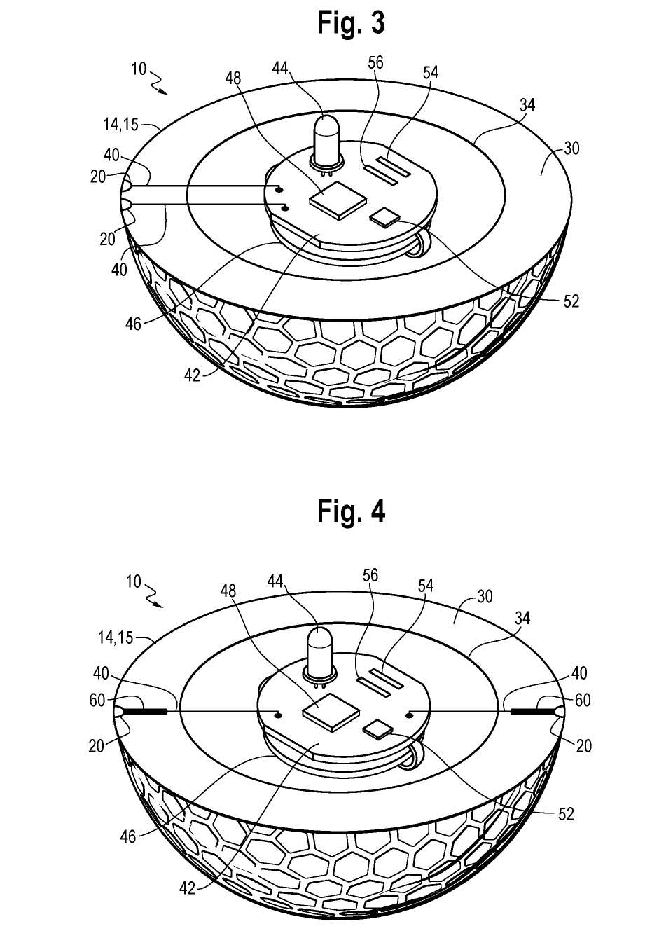

Referring to FIGS. 1-7, one embodiment of a touch activated lighted sports ball 10 of the present disclosure includes an outer layer 14 that is generally in the shape of a sphere, but can be made in other shapes that are used for sports balls. The outer layer 14 can be constructed of a transparent or translucent plastic material, such as a translucent plastic thermoset material that can be molded to a desired shape. The outer layer 14 can be sealed and enclose a core 34 which contains an electronic circuit 42 described below.

The sports ball 10 includes a pair of electrodes 40 exposed on an exterior surface 15 of the outer layer 14, as shown in FIG. 1. The electrodes 40 couple to an electronic circuit 42 that is disposed within the core 34. The circuit 42 includes a battery 46, a lamp 44, an active circuit element 48, and an electronic switch 52 connected to the pair of electrodes 40. The circuit 42 is responsive to current flowing through a low resistance path between the pair of electrodes 40, to energize the lamp 44.

Each of the pair of electrodes 40 may be located on opposite sides of the sports ball 10, as shown in cross-sectional views FIGS. 2 and 4. By having the pair of electrodes 40 on opposite sides of the sports ball 10, the sports ball 10 may be balanced and may perform better during a sporting activity. This feature may be important if the sports ball 10 is, for example, a golf ball. Golf is often a competitive sport and any advantage gained improves player performance; therefore, having a balanced sports ball 10 may be an advantage for competitive golf players.

The sports ball 10 may have a pair of electrodes 40 arranged side-by-side on the sports ball 10. By having the pair of electrodes 40 located close together on sports ball 10, the lamp 44 may be easily actuated, if the sports ball 10 is, for example, a golf ball. For example, a single finger or thumb can contact both electrodes 40 to activate the lamp 40. Miniature golf, a recreational sport may have younger players, such as, for example, a child with small hands. Easily actuating the lamp 44 of sports ball 10 may be advantageous to a child playing miniature golf.

The sports ball 10 may have a plurality of dimples 20 that cover the exterior surface 15 of the outer layer 14. The dimples 20 may improve the aerodynamics of the sports ball 10. Each of the electrodes 40 may be flush with the exterior surface 15 of the outer layer 14 and may be centrally located within one of the plurality of dimples 20, as shown in FIGS. 1-4.

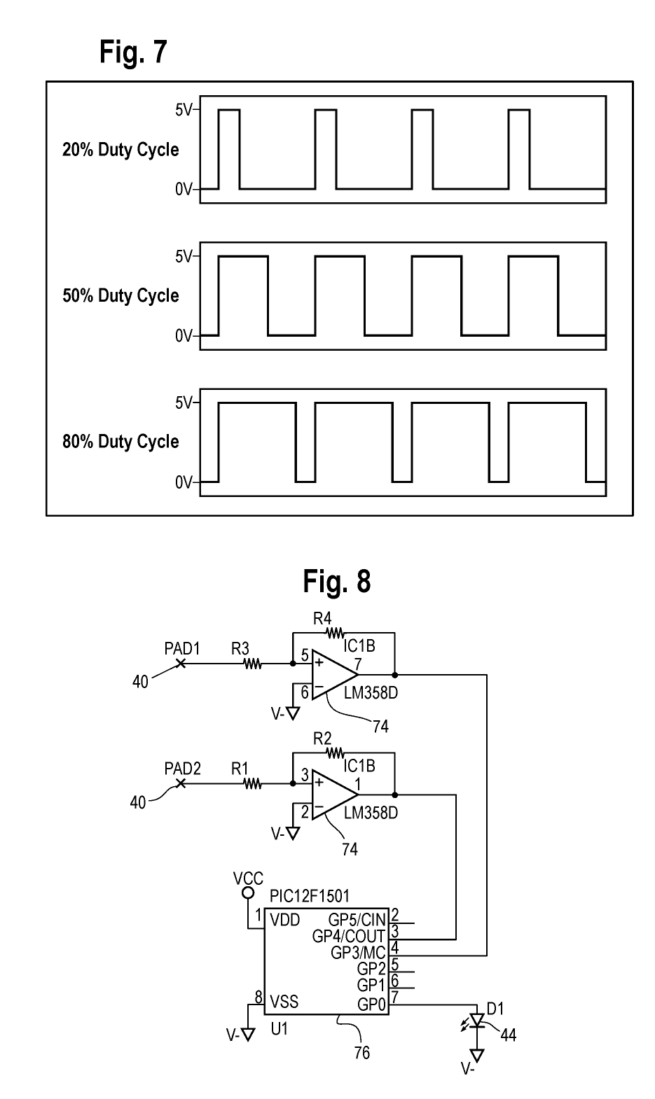

The outer layer 14 may be translucent. When the lamp 44 is energized, light may be emitted through the outer layer 14. The emitted light may increase visibility of the sports ball 10 when ambient light is low, for example, at night. As shown in FIGS. 1 and 7, when not lighted, the golf ball 10 appears visually the same as common golf balls.

The active circuit element 48 includes a timer for a preset period of time the lamp 44 is energized subsequent to an electrical low resistance across the pair of electrodes 40. The timer is initiated by the electronic switch 52 when the low resistance across the pair of electrodes 40 occurs. When the timer expires, the electronic switch 52 may disconnect the active circuit element 48 from the battery 46 and thereby deenergized the lamp 44. A subsequent occurrence of an electrical low resistance across the pair of electrodes 40 may also deenergize the lamp 44 prior to expiration of the timer.

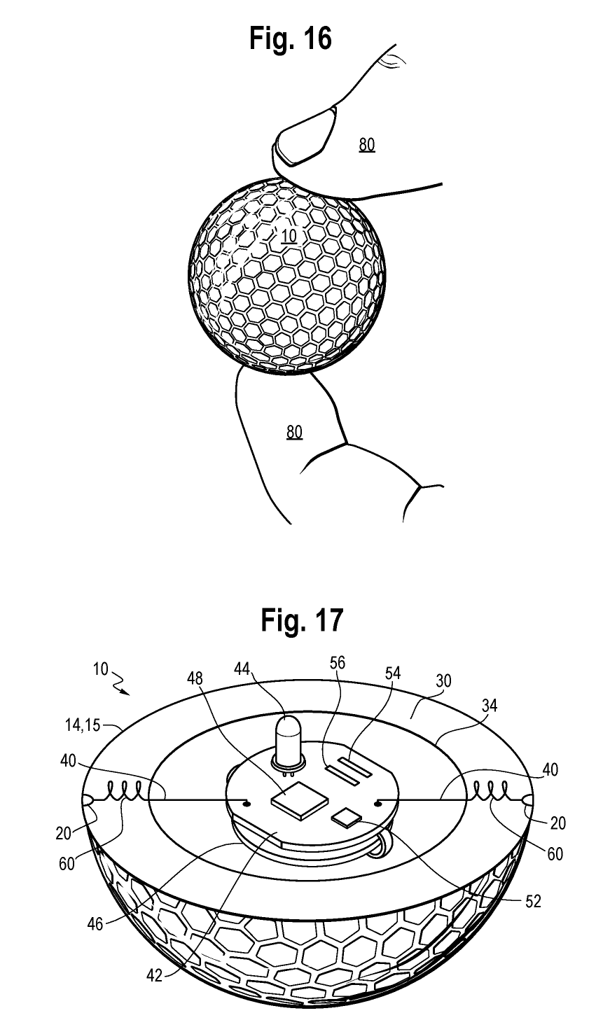

Referring to FIG. 6, an embodiment of the sports ball 10 may include differently colored lamps 44 and 72. The lamps 44, 72 may each be actuated, independently. To actuate lamps 44, 72 independently may include a sequence of an electrical low resistance across the pair of electrodes 40, each expressly followed by an electrical high resistance across the pair electrodes 40, and repeating the sequence until the lamps 44, 72 each have independently been energized and deenergized. The low resistance path may occur when the pair of electrodes 40 are simultaneously touched by human skin 80, for example, such as, one or more fingers and/or thumb of a human hand, as shown in FIG. 16, or a conductive liquid, for example, water.

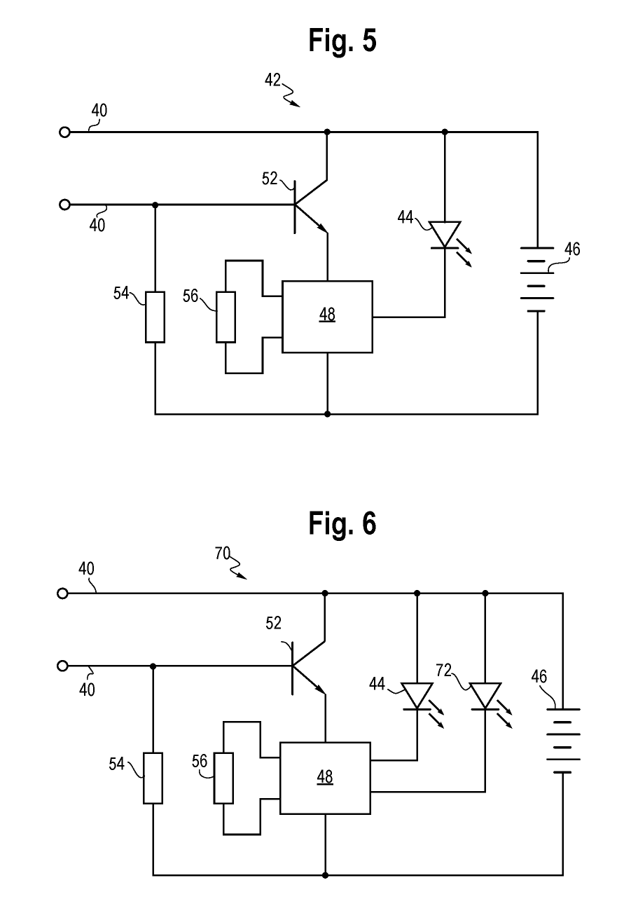

Referring to FIG. 5, one embodiment of an electronic circuit 42 suitable for use within the sports ball 10 includes an active circuit element 48, first resistor 54 and second resistor 56, electronic switch 52, lamp 44 and battery 46 interconnected. Electronic switch 52 may be a transistor. Also included is a pair of spaced electrodes 40 embedded in the exterior surface 15, of the outer layer 14. A suitable lamp 44 is commercially available from Chi Ban Electronics Company Limited, Shenzhen, China, as part number 5X3VC, where the letter “X” designates the color, e.g., “R” for red, “G” for green, and “W” for white. The active circuit element 48 can be in die form and may be an AP3761-03 IC commercially available from Advanced Microelectronic Products, Inc., Taiwan.

The electronic circuit 42 configuration shown in FIG. 5, including the electronic switch 52 and first resistor 54 and second resistor 56, and its power supply input is connected to the emitter of electronic switch 52 which thereby controls the supply of power to the active circuit element 48. The active circuit element 48 has an output connected to the cathode of lamp 44 as shown in FIG. 5. First resistor 54 controls the clock frequency of the active circuit element 48 and second resistor 56 is a pull-down resistor provided to hold the electronic switch 52 off when the base thereof is open. Electrodes 40 can be constructed of a corrosion-resistant metal alloy such as brass or stainless steel, as they may contact water, and other liquids and substances commonly found in sporting environments. Nickel-plated copper is particularly suitable. A pair of wires connects electrodes 40 to the battery positive terminal and to the base of electronic switch 52. Thus, when a low resistance occurs across the pair of electrodes 40, it completes a circuit between the battery 46 and the base of the electronic switch 52 and thereby causes the electronic switch 52 to turn on and supply power to the active circuit element 48.

The active circuit element 48 may be wire bonded to operate in a “Lever Hold” mode whereby the lamp 44 output is held low, and the lamp 44 is thereby held on, whenever the electronic switch 52 is energized. When the switch is opened, power is removed from the active circuit element 48 and the lamp 44 when a timer internal to active circuit element 48 expires, whereby the circuit is completely deenergized. The active circuit element 48 is immediately retriggered and the lamp 44 turned on when the electronic switch 52 is energized again. The timer may be preset, for example, for 15 minutes, or ½ hour, or any other desired preset values.

The AP3761-03 IC may alternatively be wire bonded to operate in a stable mode, thereby causing continuous flashing of the lamp 44, whenever the electronic switch 52 is closed.

Referring to FIG. 6, an alternative embodiment of the electronic circuit 42 is shown that is substantially the same as the embodiment of FIG. 5, except for the addition of color lamp 72, as described above.

An alternative embodiment of sports ball 10, shown in FIG. 4, includes a pair of electrodes 40. The electrode 40 can be coupled to a side of soft conductive material 60, coupled to the other side of soft conductive material 60 can be one of the plurality of dimples 20. The soft conductive material 60 may be flush with the exterior surface 15 of the outer layer 14 and centrally located within one of the plurality of dimples 20.

An alternative embodiment of sports ball 10, shown in FIG. 17, includes a conductive bend 62 electrically coupled to electrodes 40 between dimple 20 and electronic circuit 42. The conductive bend 62 allow the electrodes 40 to flex, for example, such as, when sports ball 10 is impacted, for example, with a golf club or other sporting equipment. The conductive bend 62 can be a spiral, twist or other configuration allowing for expansion and contraction of conductive bend 62 due to application of force by, for example, sporting equipment or changes in environmental conditions, for example, such as, ambient temperature changes.

Multiple sports balls 10 may be used by different players competing against each other, for example, in a game of golf. The different sports balls 10 may include different color lamps 44, or different colors in the core 34, outer layer 14, or an intermediate layer to make the illumination appear a different color for different sports balls 10.

The sports ball 10 may include other features, for example, within the electronic circuit 42. For example, the circuit 42 can be configured such that the touch activated circuit activates the LED light and controls the LED light in a pulse width modulated (PWM) manner, as illustrated in FIG. 7. Such a circuit 42 configuration may save energy and extend battery life. In addition, the circuit 42 may include a voltage detector. The circuit 42 that activates the LEDs can reset or turn off after the battery 46 is depleted by some number of volts, as detected by the voltage detector, instead of a pre-determined length of time. This allows for more consistent illumination during the life of the circuit/battery combination rather than running the battery 46 dead over some pre-determined period of time. For example, after the user turns the 10 ball on, an internal voltage monitor or voltage detector which is part of the circuitry 76 (see FIG. 8), and is common on many circuits as a low battery sensor, compares a difference in voltage at a given time to the starting voltage as the battery 46 depletes. When the battery 46 depletes, for example, some hundredths of a volt, the circuit 42 de-energizes. The exact voltage drop can be predetermined to get sufficiently long play time between activations and/or resets of the circuit 42. The voltage monitoring in conjunction with PWM control of the circuit 42 and LEDs 46 allows for longer play time than existing LED golf balls. The circuit 42 can be configured such that if the circuit 42 is already energized, it will remain energized for an additional voltage decay cycle if the activation switch (e.g., the electrodes 40) are again contacted or re-contacted.

Optionally, the circuit 42 can be configured so that the user can deactivate the circuit 42 (e.g., the ball 10 illumination) by touching the electrodes 40 a predetermined number of times (for example, touching the electrode 40 two times in quick succession). That is, one touch on the electrodes 40 will energize the circuit 42 (and thus illuminate the ball 10), and two quick touches in quick succession will turn off the circuit 42 (and thus de-illuminate the ball 10).

The circuit 42 can also include an impact-type switch, such as a known spring or BB-type switch to energize the circuit 42 in addition to the electrode 40 energization of the circuit 42. The circuit 42 can also be configured such that touching the electrodes 40 to energize the circuit 42 operates in conjunction with the impact-type switch 78 (the internal inertia or shock activated switch) to allow the circuit 42 to illuminate in one color and then, for example, upon striking the illumination changes to some other color, color patterns or intensity of the lamps, e.g., the LEDs 44, 72. In yet another optional configuration of the circuit 42, upon landing, if the impact-type switch is activated, it can be engaged to change colors or light intensity of the lamps, e.g., the LEDs 44, 72.

The circuit 42 and the lamps, e.g., the LEDs 44, 72 can also be configured so that the lights/illumination are provided in different colors, which colors may, for example, be selected by successive touching of the electrodes 40. The selected color may “lock” into place or may be reset by any of the aforementioned actions. The circuit 42 may also configured to provide a continuous color changing mode (again by a some touch pattern of the electrodes 40 when activating the circuit 42 ball, and the user can then lock the illumination to the selected color, for example, unless or until the reset pattern is achieved or the circuit 42 remains deenergized for a predetermined time.

Examples of circuit diagrams for the touch activated lighted sports ball are provided in FIGS. 8-12. Referring to FIG. 8, this circuit is a two-touch circuit in which two electrodes or pads 40 are each connected to respective operational amplifiers 74 which in turn are connected to an integrated circuit (or circuitry, generally), 76. An LED 44 is connected to an controlled by the circuit 76. In this configuration, the circuit 76 can be configured so that illumination of the LED 44 is controlled and can be varied. For example, a single touch of the pad 40 can turn on the LED 44, a second touch can activate the circuit 76 to sequence the LED to pulse, to flash or any operate under in other desired, predetermined manner.

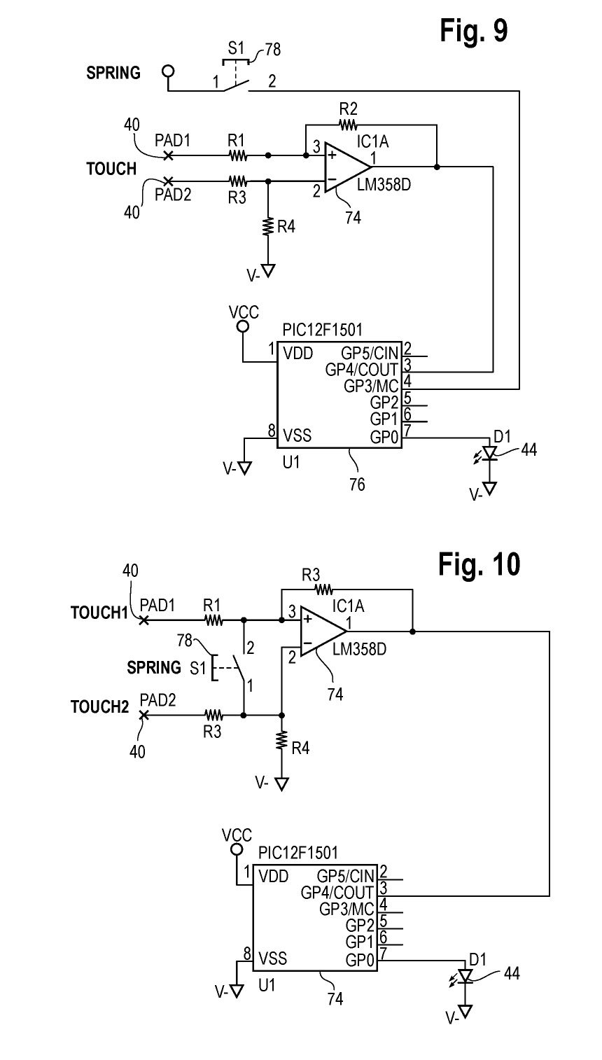

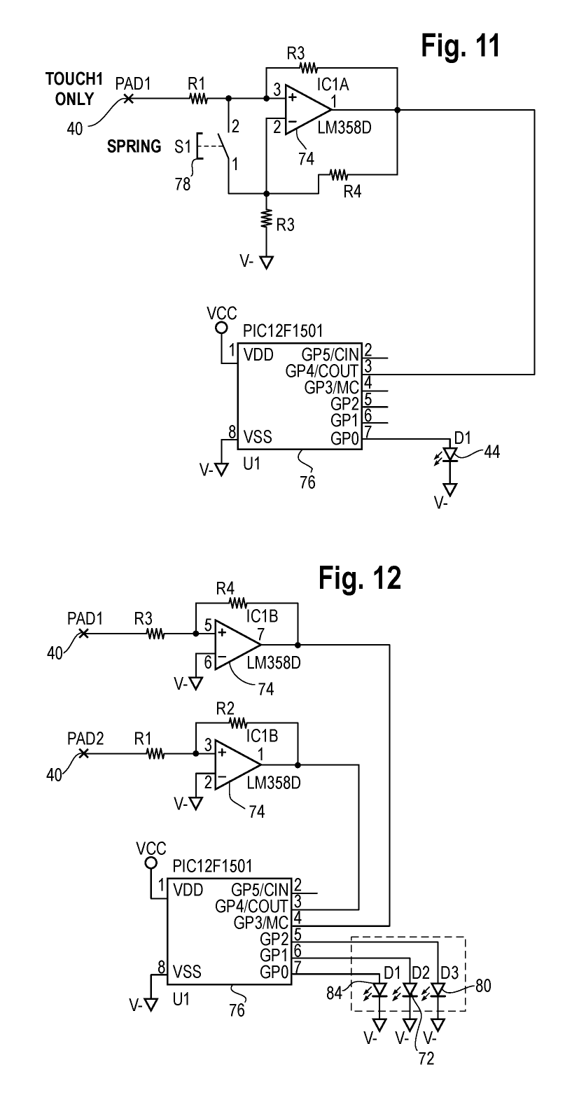

FIG. 9 illustrates a less complex system in which touching both pads 40 activates the circuit 76 to illuminate the LED 44. This configuration also shows and optional impact actuated switch 78. In this configuration, either touching the pads 40 or impacting (e.g., hitting) the ball 10 will activate the circuit 76 and illuminate the LED 44. FIG. 10 shows an alternative configuration in which the two touch pads 40 or the impact switch 78 can be used to activate the circuit 78 and illuminate the LED 44. FIG. 11 illustrates an example of a configuration in which a single touch pad 40 can be used to illuminate the LED 44. Also shown in FIG. 11 is the impact actuated switch 78 that can be used to illuminate the LED 44. It will be appreciated that the ability to actuate the circuit 76 by touching a single pad 40 is quite unexpected in that there is apparent completion of the electrical circuit. Nevertheless, it has been found that contacting or touching the single pad 40 functions to actuate the circuit 76 and illuminate the LED 44. FIG. 12 is an example of a configuration similar to that of FIG. 10, e.g., a variably controllable circuit, having multiple LEDs 44, 72, 80. In this configuration, varying the length or number of touches on the pads 40 can serve to illuminate the LEDs 44, 72, 80 in various sequences, and in different colors if, for example, the LEDs 44, 72, 80 are different colored LEDs. While FIG. 12 illustrates three separate LEDs 44, 72, 80, those skilled in the art will appreciate that a single, multiple-color LED can be used instead.

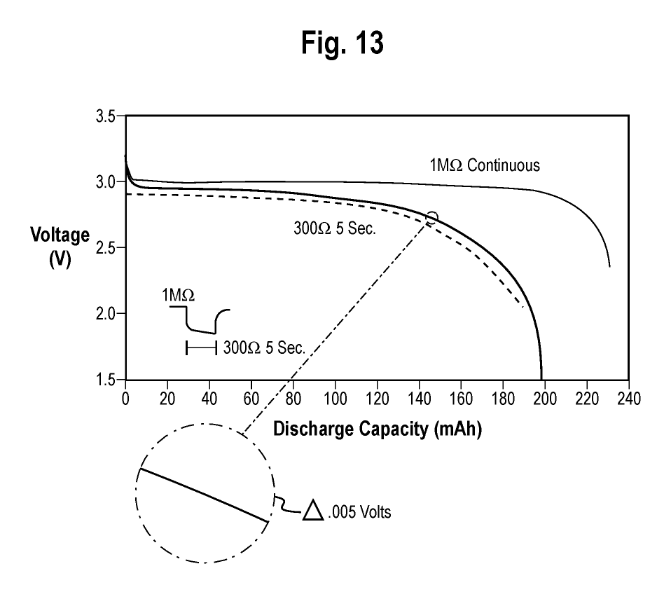

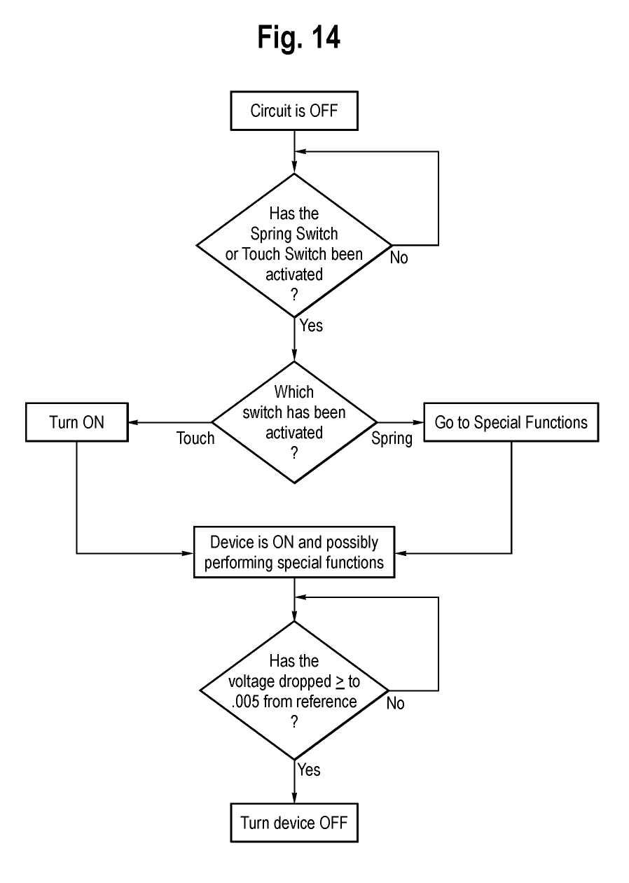

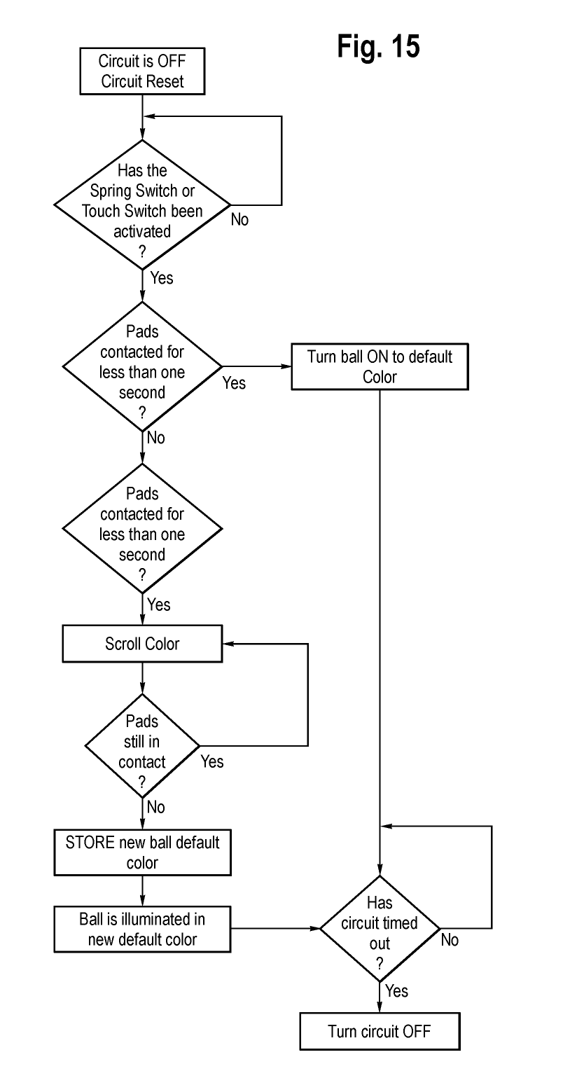

FIG. 13 illustrates the voltage drop vs. the discharge capacity of an example circuit showing change of voltage of about 0.005 volts. FIGS. 14 and 15 are examples are of operating flow diagrams for different circuits and scenarios for the touch activated illuminated sports ball.

While the device has been illustrated and described in detail in the foregoing drawings and description, the same is to be considered as illustrative and not restrictive in character, it being understood that only illustrative embodiments thereof have been shown and described and that all changes and modifications that come within the spirit and scope of the present disclosure as defined in the claims and summary are desired to be protected.

1. A sports ball, comprising:
a core and an outer layer;
a pair of electrodes exposed on an exterior surface of the outer layer;
an electronic circuit disposed within the core, the circuit including a battery, a lamp, an active circuit element, and an electronic switch connected to the pair of electrodes, the electronic circuit responsive to current flowing through a low resistance path between the electrodes, to energize the lamp.

2. The sports ball of claim 1, wherein the pair of electrodes are arranged on opposite sides of the ball.

3. The sports ball of claim 1, wherein the pair of electrodes are arranged adjacently on the same side of the ball.

4. The sports ball of claim 2, further comprising a plurality of dimples defined by exterior surface of the outer layer.

5. The sports ball of claim 4, wherein the pair of electrodes are flush with the exterior surface of the outer layer and each of the pair of electrodes are located centrally within one of the plurality of dimples.

6. The sports ball of claim 5, wherein the outer layer is translucent.

7. The sports ball of claim 6, wherein the active circuit element includes a timer, initiated by the electronic switch.

8. The sports ball of claim 7, wherein the lamp turns off when the timer expires.

9. The sports ball of claim 7, wherein the electronic switch disconnects the active circuit from the battery when the timer expires and thereby deenergizes the lamp.

10. The sports ball of claim 1, wherein the lamp is a light emitting diode (LED).

11. The sports ball of claim 11, wherein the LED includes a plurality of different color LEDs.

12. The sports ball of claim 11, wherein the plurality of different color LEDs rotate through each color LED independently, in a sequence in response to repeated presentment and absence of electrical low resistance across the pair of electrodes.

13. The sports ball of claim 12, wherein the sequence includes the electrical low resistance between the pair of electrodes, followed by a high electrical resistance between the pair of electrodes, and repeating the cycle until the lamp deenergizes.

14. The sports ball of claim 13, wherein the low resistance path occurs when the pair of electrodes are simultaneously touched by human skin.

15. The sports ball of claim 1, wherein the sports ball is a golf ball.

16. The sports ball of claim 2, further comprising a soft conductive material electrically coupled between the electrode and the exterior surface of the outer layer.

17. The sports ball of claim 2, further comprising a conductive bend electrically coupled to the electrode between the exterior surface and the electronic circuit.

18. The sports ball of claim 6, wherein the active circuit element includes a voltage detector initiated by the electronic switch.

19. The sports ball of claim 18, wherein the lamp turns off when a predetermined change in battery discharge voltage is detected by the voltage detector.
